(19) United States
(12) Patent Application Publication
(10) Pub. No.: US 2026/0054961 A1
(43) Pub. Date: Feb. 26, 2026

(54) CONTROL NETWORK MANAGEMENT

(71) Applicant: KONE Corporation, Helsinki (FI)

(72) Inventors: Matti Laakso, Helsinki (FI); Mikko-Ville Määttä, Helsinki (FI)

(73) Assignee: KONE Corporation, Helsinki (FI)

(21) Appl. No.: 19/269,341

(22) Filed: Jul. 15, 2025

Related U.S. Application Data
(63) Continuation of application No. PCT/FI2023/050175, filed on Mar. 29, 2023.

(51) Int. Cl. B66B 1/34; B66B 25/00

(52) U.S. Cl. CPC B66B 1/3453; B66B 25/00

(57) ABSTRACT

According to an example embodiment, a method (200, 200′) for managing access to a control network of a people flow system (101) is provided, where the people flow system (101) includes a passenger conveyor system (101) and a conveyor system controller (110), where the site control network (105) communicatively couples the conveyor system controller (110) to a network coordinator (120) and to one or more further apparatuses (130), the method comprising: admitting (202), by the network coordinator (120), the one or more further apparatuses (130) to the site control network (105) via carrying out a respective pairing procedure with each of said one or more further apparatuses (130) based on a predefined shared secret; adding (204), by the network coordinator (120), a respective device identifier, ID, of each further apparatus (130-k) to a list of apparatuses admitted to the site control network (105); transmitting (206) said list from the network coordinator (120) to an external entity (110, 150) for storage therein; and creating (208, 208′), following a loss of site network control information in the network coordinator (120), a restored site control network (105′) in one of the network coordinator (120) or the replacement network coordinator (120′), said creating (208, 208′) comprising receiving (208a, 208a′) said list from the external entity (110, 150); and automatically admitting (208b, 208b′) an apparatus to the restored site control network (105), provided that said apparatus has its device ID included in said list and has a knowledge of the predefined shared secret.

### TECHNICAL FIELD

The example and non-limiting embodiments of the present invention relate to management of a control network that is applicable for communicatively coupling to each other a plurality of network nodes that relate to controlling operation of people flow equipment such as elevators and/or escalators.

### BACKGROUND

Many advanced people flow systems further involve various support systems in addition to one or more elevators and/or one or more escalators that serve for the actual passenger transport at a site, such as lighting and ventilation. In this regard, both the actual transport systems and the support systems typically operate under respective control systems. Moreover, the people flow system typically further involves various devices that supply information to the control systems and/or receive information from the control systems, such as control panels (e.g. call terminals) arranged at the site for receiving user input such as transport calls from passengers of the people flow system, display devices for displaying information to passengers, one or more sensors arranged for monitoring respective environmental characteristic at the site, etc.

In order to efficiently share information related to the control of various aspects of the people flow system, the respective control systems and various other devices of the people flow system are typically communicatively coupled to each other via a communication network, which may be referred to as a site control network or as a site network. The site control network may be further connected to other networks provided at the site, such as one or more other site control networks and/or a building automation network.

On one hand, efficient and reliable transfer of information over the site control network is typically critical for correct and timely operation of the underlying people flow equipment at the site, while on the other hand allowing connections to the site control network by external devices poses a security risk. Hence, typically only those devices that are considered necessary for operation of the people flow equipment are allowed to join the site control network. To this end, the site control network typically includes a coordinator apparatus for managing access to the site control network e.g. via keeping track of devices coupled to the site control network and via admitting any new devices that wish to join the site control network via a pairing procedure that involves authentication of the device that wishes to join the site control network.

While usage of the coordinator apparatus is applicable for ensuring secure operation of the site control network despite devices leaving and joining the site control network e.g. due to introducing new devices to the people flow equipment or replacing malfunctioning devices of the site control network with new ones, there is a challenge involved in replacing the coordinator apparatus with a new one, which may be necessary e.g. due to malfunction of the coordinator apparatus or simply due to a need upgrade the coordinator apparatus. In practical point of view, replacement of the coordinator apparatus with a new one may require re-establishment of the site control network via repeating the pairing procedure with respect to each device of the site control network with the new coordinator apparatus, which in many scenarios requires manual work that is both cumbersome and prone to human errors, thereby running a risk of prolonged unavailability of passenger transport via operation of the underlying people flow equipment.

### SUMMARY

It is an object of the present invention to provide a technique that facilitates efficient and secure re-establishment of a site control network applied for controlling at least some aspects of operation of a people flow system provided at the site upon loss of network configuration information at a network coordinator entity of the site control network.

According to an example embodiment, a method for managing access to a control network of a people flow system is provided, where the people flow system includes a passenger conveyor system and a conveyor system controller, where the site control network communicatively couples the conveyor system controller to a network coordinator and to one or more further apparatuses, the method comprising: admitting, by the network coordinator, the one or more further apparatuses to the site control network via carrying out a respective pairing procedure with each of said one or more further apparatuses based on a predefined shared secret; adding, by the network coordinator, a respective device identifier, ID, of each further apparatus to a list of apparatuses admitted to the site control network; transmitting said list from the network coordinator to an external entity for storage therein; and creating, following a loss of site network control information in the network coordinator, a restored site control network in one of the network coordinator or the replacement network coordinator, said creating comprising receiving said list from the external entity; and automatically admitting an apparatus to the restored site control network, provided that said apparatus has its device ID included in said list and has a knowledge of the predefined shared secret.

According to another example embodiment, an apparatus for managing access to a control network of a people flow system is provided, where the control network includes a passenger conveyor system and a conveyor system controller, where the site control network communicatively couples the conveyor system controller to the apparatus and to one or more further apparatuses, the apparatus arranged to: admit the one or more further apparatuses to the site control network via carrying out a respective pairing procedure with each of said one or more further apparatuses based on a predefined shared secret; add a respective device identifier, ID, of each further apparatus to a list of apparatuses admitted to the site control network; transmit said list to an external entity for storage therein; create, following a loss of site network control information in the apparatus, a restored site control network, said creating comprising the apparatus arranged to: receive said list from the external entity, and automatically admit another apparatus to the restored site control network, provided that said another apparatus has its device ID included in said list and has a knowledge of the predefined shared secret.

According to another example embodiment, a control system for managing access to a control network of a people flow system is provided, where the people flow system includes a passenger conveyor system and a conveyor system controller, where the site control network communicatively couples the conveyor system controller to a network coordinator apparatus and to one or more further apparatuses, the control system comprising: the network coordinator apparatus arranged to: admit the one or more further apparatuses to the site control network via carrying out a respective pairing procedure with each of said one or more further apparatuses based on a predefined shared secret, add a respective device identifier, ID, of each further apparatus to a list of apparatuses admitted to the site control network, and transmit said list to an external entity for storage therein; and a replacement network coordinator apparatus arranged to create, following a loss of site network control information in the network coordinator apparatus, a restored site control network, said creating comprising the replacement network coordinator apparatus arranged to: receive said list from the external entity; and automatically admit another apparatus to the restored site control network, provided that said another apparatus has its device ID included in said list and has a knowledge of the predefined shared secret.

According to another example embodiment, a computer program for managing access to a control network is provided, the computer program comprising computer readable program code configured to cause performing at least the method according to the example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some logical elements of a people flow system according to an example;

FIG. 2 illustrates a method according to an example;

FIG. 3 illustrates a block diagram of some logical elements of a people flow system according to an example;

FIG. 4 illustrates a method according to an example; and

FIG. 5 schematically illustrates an apparatus according to an example.

### DESCRIPTION OF SOME EMBODIMENTS

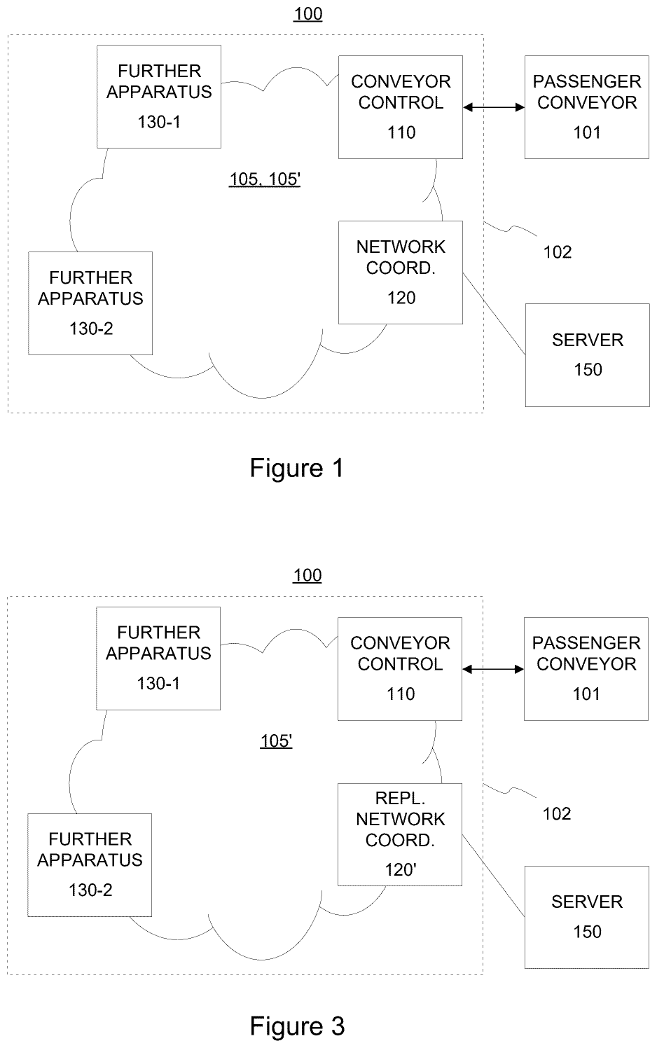

FIG. 1 illustrates a block diagram of some logical elements of a people flow system 100 according to an example, including a passenger conveyor system 101 and conveyor system controller 110, where the passenger conveyor system 101 may comprise one or more elevators and/or one or more escalators arranged at a site for transporting passengers. The people flow system 100 may be also referred to as a passenger conveyor system. The conveyor system controller 110 may be communicatively coupled via a communication network 105 to one or more further apparatuses 130, the conveyor system controller 110 and the one or more further apparatuses 130 hence serving as respective nodes of the communication network 105 and they may be also considered as respective elements of a control system 102 associated with the people flow system 100. In this regard, the example of FIG. 1 illustrates further apparatuses 130-1 and 130-2 that represent the one or more further apparatuses 130, whereas any single further apparatus may be referred to as a further apparatus 130-k.

The control system 102 further comprises a network coordinator 120 coupled to the communication network 105, which may be implemented as a network coordinator apparatus that is separate from other nodes of the communication network 105 (as illustrated in the example of FIG. 1) or as an element integrated to another node of the communication network 105. As an example of the latter, the network coordinator may be implemented as part of the conveyor system controller 110.

The one or more further apparatuses 130 coupled to the communication network 105 may include one or more apparatuses operated at the site in order to provide the conveyor system controller 110 with information that is applicable for controlling one or more aspects of operation of the passenger conveyor system 101 and in the framework of the present disclosure such apparatuses may be also referred to as respective data source apparatuses. Additionally or alternatively, the one or more further apparatuses coupled to the communication network 105 may comprise one or more apparatuses that receive information regarding operation and/or usage of the people flow system 100 from the conveyor system controller 110 and further provide this information to passengers of the passenger conveyor system 101 at the site. In the framework of the present disclosure such apparatuses may be also referred to as respective data sink apparatuses 140. Hence, the communication network 105 serves to couple the one or more further apparatuses 130 that are operated at the site to the conveyor system controller 110 and to each other and, consequently, the communication network 105 may be also referred to as a site control network or as a site network.

The example of FIG. 1 further illustrates a server entity 150, whereas the network coordinator 120 may be communicatively coupled to the server entity 150. The server entity 150 is not included in the site control network 105 but it may be communicatively coupled to the network coordinator 120 independently of the site control network 105 and hence it may be also referred to as an external server entity. The server entity 150 may be provided as a server apparatus (which may be provided at the site or at a remote location) or as a plurality of server apparatuses arranged to provide a cloud computing service (typically provided at a remote location).

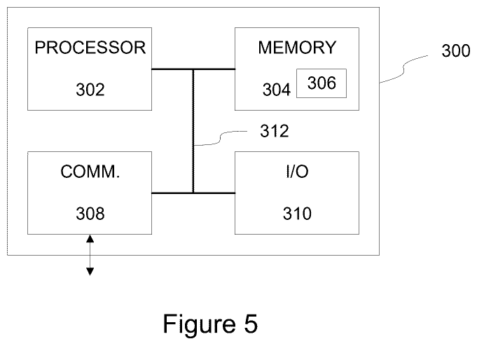

The conveyor system controller 110 may be arranged to control one or more aspects of operation of the passenger conveyor system 101, where the manner of controlling the passenger conveyor system 101 may be at least partially based on data received over the site control network 105 from one or more data source apparatuses included in the site control network 105. In this regard, the conveyor system controller 110 may include one or more controller apparatuses, e.g. one or more elevator system controllers and/or one or more escalator system controllers, depending on the configuration of the passenger conveyor system 101 operated at the site. Each controller apparatus of the conveyor system controller 110 may comprise a computer apparatus that include one or more processors and one or more memories storing one or more computer programs, where the one or more processors may execute the one or more computer programs stored at the one or more memories to cause the computer apparatus to operate as the respective controller apparatus of the conveyor system controller 110. More detailed examples in this regard are described later in this text with references to FIG. 5.

In this regard, it is worth noting that in context of the present disclosure, an aspect of interest in relation to the people flow system 100 is an aspect of managing the site control network 105 and, therefore, any aspects related to the structure and operation of the passenger conveyor system 101 as well as any aspects related to operation of the conveyor system controller 110 may be provided using techniques known in the art and, consequently, any details in this regard are described herein only to extent they are necessary for describing examples that pertain to management of the site control network 105 in accordance with the present disclosure.

Along the lines described in the foregoing, a further apparatus 130-k coupled to the site control network 105 may comprise a data source apparatus, which may be operated at the site and arranged to receive, capture and/or otherwise acquire data that is applicable for controlling one or more aspects of operation of the passenger conveyor system 101 and for transmitting the data acquired therein over the communication site control network 105 to the conveyor system controller 110. The data source apparatus may be further arranged to transmit the respective data acquired therein over the site control network 105 to one or more other nodes of the site control network 105 and/or to receive information, such as control data, over the site control network 105 e.g. from the conveyor system controller 110.

Along similar lines, a further apparatus 130-k coupled to the site control network 105 may comprise a data sink apparatus, which may be arranged to receive information regarding operation and/or usage of the people flow system 100 over the site control network 105 from the conveyor system controller 110 and e.g. to present the received information to passengers of the passenger conveyor system 101 at the site and/or to store the received information therein e.g. for monitoring or analysis purposes. The data sink apparatus may be further arranged to receive, over the site control network 105, respective data from one or more other apparatuses coupled to the site control network 105, e.g. from one or more data source apparatuses and/or transmit information, such as requests to receive certain data, over the site control network 105 e.g. to the conveyor system controller 110.

The one or more further apparatuses 130 of the site control network 105 may further comprise one or more network traffic management apparatuses, e.g. ones applicable for segmenting the site control network 105 and/or for extending a coverage of the site control network 105 (if provided as a wireless communication network). While operation of such a traffic management apparatus may involve receiving and transmitting data via the site control network 105, such apparatuses may not strictly constitute a data source apparatus or a data sink apparatus in the meaning of the present disclosure.

Each of the one or more further apparatuses 130 may comprise a respective computer apparatus that includes one or more processers and one or more memories storing one or more executable computer programs, whereas the one or more processor of the respective computer apparatus executing the one or more executable computer programs stored at the one or more memories of the respective computer apparatus cause the respective computer apparatus to serve as the respective further apparatus 130-k. More detailed examples in this regard are described later in this text with references to FIG. 5.

In the framework of the present disclosure the term data source apparatus serves as a generic term that is intended to encompass any apparatus operated at the site and coupled to the site control network 105 for the purpose of receiving, capturing or otherwise acquiring information that is applicable for controlling at least one aspect of operation of the passenger conveyor system 101 via operation of the conveyor system controller 110. Non-limiting examples of such data source apparatuses include the following:
User interface devices such as call panels that are applicable for receiving transport calls from passengers at the site and/or control panels of other kind that are applicable for entering user input for operating the passenger conveyor system 101.
Sensor devices including one or more sensors arranged to monitor respective environmental characteristics at the site in general or at a certain location of the people flow system 100, such as presence of one or more passengers, temperature, light level, etc.

Moreover, in the framework of the present disclosure the term data sink apparatus serves as a generic term that is intended to encompass any apparatus operated at the site and coupled to the site control network 105 for the purpose of receiving, from the conveyor system controller 110 or from another node of the site control network 105, information that is descriptive of operation and/or usage of the people flow system 100 to enable displaying the received information at the site to passengers of the passenger conveyor system 101, to control at least some aspects of lighting at the site in relation to the people flow system 100 and/or to enable monitoring or analysis of operation of the people flow system 100. Non-limiting examples of such data sink apparatuses include the following:
A display device for displaying, at the site, information regarding one or more aspects of operational status of the passenger conveyor system 101 or the people flow system 100 in general and/or guidance information for passengers of the passenger conveyor system 101 in view of current operational status of the passenger conveyor system 101 or the people flow system 100 in general.
A control device for controlling, at the site, lighting and/or visual effects of other kind provided for passengers of the passenger conveyor system 101 or the people flow system 100 in general.
A monitoring device for storing data that is descriptive of operational status of the passenger conveyor system 101 or the people flow system 100 in general for subsequent analysis of operation of the passenger conveyor system 101 or the people flow system 100 in general.

The site control network 105 may comprise a wireless communication network, a wired communication network, or a combination of a wireless and wired communication networks. For the sake of an example, in the following usage of a wireless communication network is assumed, whereas the operation described with references to the wireless communication network applies to scenarios where a wired network or a combination of a wireless and wired networks is applied instead, mutatis mutandis.

As an example in this regard, the site control network 105 may be provided via usage of a suitable short-range wireless communication technique known in the art, which may enable communication over ranges from a few meters up to a hundred meters. Examples of suitable short-range wireless communication techniques include Bluetooth, Bluetooth Low-Energy (BLE), ZigBee, WLAN/Wi-Fi according to an IEEE 802.11 family of standards, etc. The choice of the wireless communication technique and network topology applied for a specific implementation of the site control network 105 may depend e.g. on the required communication range and/or requirements with respect to energy-efficiency of the applied communication technique. As a non-limiting example in this regard, the site control network 105 may be provided using a wireless mesh network model, for example a mesh network according to the Bluetooth or BLE Mesh networking protocol known in the art.

The network coordinator 120 may comprise a computer apparatus that includes one or more processors and one or more memories storing one or more computer programs, where the one or more processors may execute the one or more computer programs stored at the one or more memories to cause the computer apparatus to operate as the network coordinator 120 according to the present disclosure. More detailed examples in this regard are described later in this text with references to FIG. 5. Along the lines described in the foregoing, according to an example, the network coordinator 120 may be implemented in an apparatus that is separate from the other nodes of the site control network 105, e.g. as a dedicated network coordinator apparatus, whereas in another example the network coordinator 120 may be implemented as an entity of another node of the site control network 105, e.g. as part of the conveyor system controller 110. Nevertheless, for clarity of description, in the following examples implementation of the network coordinator 120 in an apparatus separate from the other nodes of the site control network is (implicitly) assumed via referring to the network coordinator 120 as a network coordinator apparatus 120, whereas explicit references to other ways of implementing the network coordinator 120 are provided where applicable.

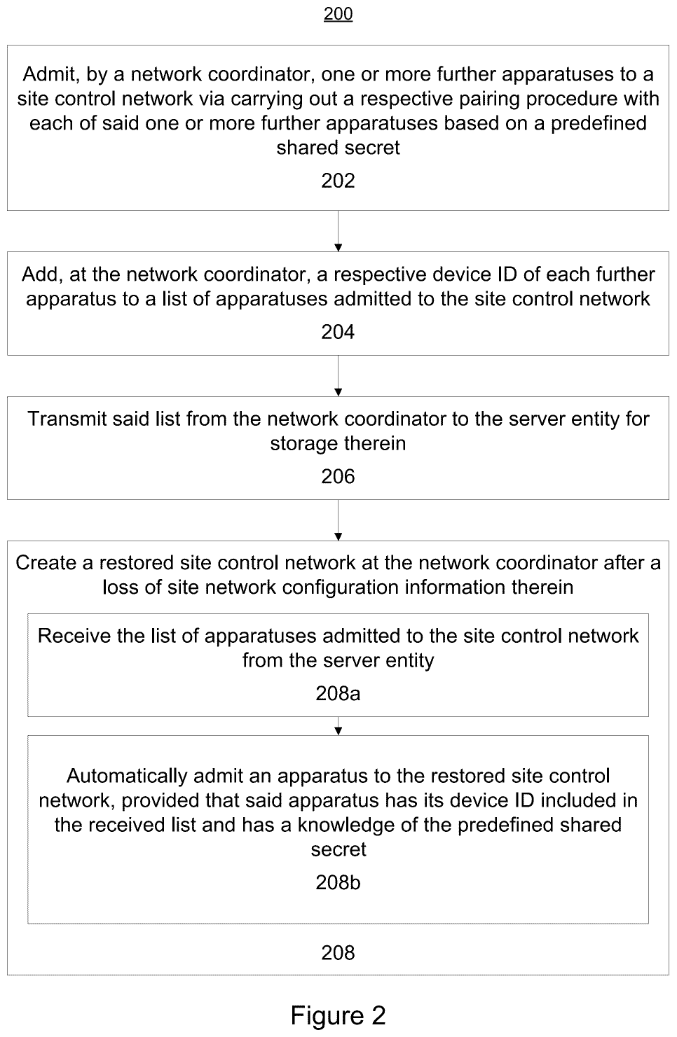

The network coordinator apparatus 120 may be arranged to manage other apparatuses at the site joining the site control network 105. In this regard, the network coordinator apparatus 120 may be arranged to admit the one or more further apparatuses 130 to the site control network 105 and to facilitate and/or implement a recovery mechanism that enables restoring the site control network 105 in case of a malfunction that results in loss of network configuration data required for management of the site control network 105. This may be provided, for example, the network coordinator apparatus 120 carrying out a method 200 illustrated in FIG. 2, which may comprise the following steps:
admit the one or more further apparatuses 130 to the site control network 105 via carrying out a respective pairing procedure with each of said one or more further apparatuses 130 based on a predefined shared secret (block 202);
add a respective device ID of each further apparatus 130-k to a list of apparatuses admitted to the site control network 105 (block 204);
transmit said list to the server entity 150 for storage therein (block 206); and
create a restored site control network 105′ at the network coordinator apparatus 120 after a loss of site network configuration information (block 208) therein, said creating comprising:
   receive the list of apparatuses admitted to the site control network 105 from the server entity 150 (block 208a), and
   automatically admit an apparatus to the restored site control network 105′, provided that said apparatus has its device ID included in the received list and has a knowledge of the predefined shared secret (block 208b).

The respective operations described with references to the method steps represented by blocks 202 to 208 may be varied or complemented in a number of ways, e.g. according to the examples described in the foregoing and/or in the following. Moreover, the method 200 may be complemented with one or more additional steps, the order of carrying out at least some of the method steps may be different from that depicted in FIG. 2.

The shared secret applied in the pairing procedure (cf. block 202) and in the creation of the restored site control network 105′ may be pre-stored at the network coordinator apparatus 120 and at the one or more further apparatuses 130 and it may be referred to as a predefined shared secret. The predefined shared secret may be stored at the network coordinator apparatus 120 and at the one or more further apparatuses 130 e.g. upon their manufacturing, upon their configuration or upon their re-configuration for operation as part of the site control network 105. Consequently, a certain apparatus having a knowledge of the predefined shared secret may serve as an indication (for the site coordinator apparatus) regarding the respective apparatus being configured for operation as part of the site control network 105. In particular, a knowledge of the predefined shared secret by a certain apparatus may serve as an indication that the respective apparatus originates from a certain manufacturer and/or that the respective apparatus is otherwise pre-approved for access to the site control network 105. Consequently, the predefined shared secret may be applied at the network coordinator device 120 to verify that an apparatus that attempts to join the site control network 105 has the authority to join the network and/or for transfer of sensitive information (such as one or more encryption keys) between the network coordinator apparatus 120 and the respective apparatus. The predefined shared secret may comprise a (pseudo-)random bit sequence of a desired length.

Before proceeding to description of respective operations of blocks 202 to 208 in further detail via respective examples, some aspects related to creation of the site control network 105 prior to carrying out the method 200 are described in the following.

Creation of the site control network 105 may comprise the network coordinator apparatus 120 defining a network link key required for communication over the site control network 105, where the network link key may comprise a (pseudo-)random bit sequence of a desired length. The network coordinator 120 may initialize the site control network 105 via admitting the conveyor system controller 110 to the site control network 105. This may be accomplished via a pairing procedure carried out with the conveyor system controller 110, which may include e.g. the following steps:
receive, at the network coordinator apparatus 120 and at the conveyor system controller 110, respective user inputs (e.g. via their respective user interfaces) to initiate the pairing procedure;
authenticate, at the network coordinator apparatus 120, the conveyor system controller 110;
verify, at the network coordinator apparatus 120, that the conveyor system controller 110 has the knowledge of the predefined shared secret; and
transmit, in response to successful verification, the network link key (possibly together other network information) from the network coordinator apparatus 120 to the conveyor system controller 110 as data encrypted using the predefined shared secreted or using an encryption key derived based on the predefined shared secret;

In this regard, the pairing procedure between the network coordinator apparatus 120 and the conveyor system controller 110 may be provided in a manner described in the following for respective pairing procedures carried out between the network coordinator apparatus 120 and the respective further apparatus 130-k, mutatis mutandis. In a scenario where the network coordinator 120 is provided as an entity of the conveyor controller 110 the pairing procedure between the network coordinator 120 and the conveyor system controller 110 is not necessary and it may be omitted.

After creation of the site control network 105 and admission of the conveyor system controller 110 to the site control network 105, the network coordinator apparatus 120 may proceed to admitting the one or more further apparatuses 130 to the site control network 105 via respective pairing procedures carried out between the network coordinator apparatus 120 and the respective further apparatus 130-k (cf. block 202). These pairing procedures are basically similar to the pairing procedure between the network coordinator 120 and the conveyor system controller 110 described above and hence they may include e.g the following steps for each of the one or more further apparatuses 130:
receive, at the network coordinator apparatus 120 and at the respective further apparatus 130-k, respective user inputs that initiate the pairing procedure;
authenticate the respective further apparatus 130-k at the network coordinator apparatus 120;
verify, at the network coordinator apparatus 120, that the respective further apparatus 130-k has the knowledge of the predefined shared secret; and
transmit, in response to successful verification, from the network coordinator apparatus 120 to the respective further apparatus 130-k, the network link key as (part of) data that is encrypted using the predefined shared secret or using an encryption key derived based on the predefined shared secret.

In this regard, the network coordinator apparatus 120 and the respective further apparatus 130-k may receive the respective user inputs that initiate the paring procedure e.g. via their respective user interfaces. This may involve a user operating a (physical) button or key provided in the respective apparatus 120, 130-k or entering respective user input via a respective user interface provided for the respective apparatus 120, 130-k. Initiation of the pairing procedure at the respective apparatuses 120, 130-k may result in carrying out a signaling between the respective apparatuses 120, 130, which may involve the respective further apparatus 130-k transmitting at least one message serving as a request for admission to the site control network 105 and the network coordinator apparatus 120 responding to the request by transmitting at least one message serving as an invitation to proceed with the admission procedure. Moreover, the exchange of the above-mentioned messages may be preceded by the network coordinator apparatus 120 indicating availability of the site control network 105 via broadcasting one or more messages that include information about characteristics of the site control network 105. The network coordinator apparatus 120 may obtain knowledge of a device ID of the respective further apparatus 130-k via one or more messages received therefrom (and vice versa) as part of this signaling exchange.

The authentication involved in the paring procedure between the network coordinator apparatus 120 and the respective further apparatus 130-k may be carried out in order to verify at the network coordinator apparatus 120 that the pairing procedure indeed concerns the respective further apparatus 130-k (instead of another apparatus within an operating range of the network coordinator apparatus 120) and it may involve e.g. the coordinator apparatus 120 receiving, as user input provided therefor, a confirmation of identity of the respective further apparatus 130-k. As an example in this regard, the authentication may involve the coordinator apparatus 120 receiving, via the user interface provided therefor, a confirmation that a predefined code displayed via the user interface of the respective further apparatus 130-k has an expected value or the coordinator apparatus 120 receiving, via the user interface provided therefor, the code displayed via the user interface of the respective further apparatus 130-k and verifying that the received code has an expected value.

Still referring to the pairing procedure between the network coordinator apparatus 120 and the respective further apparatus 130-k, as an example, the aspect of the network coordinator apparatus 120 verifying that the respective further apparatus 130-k has the knowledge of the predefined shared secret may comprise a challenge-response authentication according to a predefined procedure. In this regard, the challenge-response procedure may also serve to confirm to the respective other apparatus 130-k that the network coordinator 120 has the knowledge of the predefined shared secret and hence that the respective other apparatus 130-k establishing a connection to an apparatus that really manages access to the site control network 105.

Along the lines described in the foregoing, after successful verification the network coordinator apparatus 120 may transmit the network link key as encrypted data to the respective further apparatus 130-k, where the encrypted data may further include other information related to the site control network 105 and/or to communication over the site control network 105. According to an example, this data transmitted from the network coordinator apparatus 120 to the respective further apparatus 130-k may be encrypted using the predefined shared secret, whereas according to another example the encryption may be carried out using an encryption key derived based on the predefined shared secret. In the latter example, the encryption key may be a device-pair-specific one and it may be derived at the both apparatuses 120, 130-k using a predefined procedure and/or algorithm provided for this purpose. Once the one or more further apparatuses 130 are admitted to the site control network 105 via the respective pairing procedures, each further apparatus 130-k is able to communicate over the site control network 105 via usage of the network link key obtained in the course of the pairing procedure. In this regard, the predefined shared secret may be subsequently also applicable, for example, for automated authentication of the respective further apparatus 130-k at the network coordinator apparatus 120 upon the respective further apparatus 130-k (re-)connecting the site control network e.g. via the challenge-response procedure.

Admitting the one or more further apparatuses 130 to the site control network 105 via application of the pairing procedure according to the method 210 (or otherwise) serves to ensure that only known trusted devices are allowed to join and connect to the site control network 105 and it hence significantly reduces the risk of unauthorized access to the site control network 105, which would run a risk of compromising reliable and secure operation of the passenger conveyor system 101 and, consequently, even pose a risk to passenger safety.

Referring now to the aspect of adding the respective device IDs of the one or more further apparatuses 130 to the list of apparatuses admitted to the site control network 105 (cf. block 204), in scenarios where the network coordinator 120 is provided as the network coordinator apparatus 120 that is separate from the other nodes of the site control network (and hence separate from the conveyor system, controller 110), also the device ID of the conveyor system controller 110 may be added to the list of apparatuses admitted to the site control network 105. Herein, the term list is to be construed broadly, encompassing any data structure that may be applied to store a set of device IDs. A respective device ID assigned to an apparatus (e.g. to the conveyor system controller 110 or to any of the one or more further apparatuses 130) may include e.g. a serial number of the respective apparatus 110, 130-k, an address assigned to the respective apparatus 110, 130-k (e.g. a medium access control (MAC) layer address of the respective apparatus 110, 130-k), a name assigned to the respective apparatus 110, 130-k, etc.

Further in this regard, the list of apparatuses admitted to the site control network 105 may constitute a part of a site control network configuration information stored at the network coordinator apparatus 120. The site control network configuration information may be stored e.g. in form of a network configuration table or a network configuration database that may include a respective entry for each of the apparatuses 110, 130-k admitted to the site control network 105, where the entry that pertains to the respective admitted apparatus 110, 130-k includes at least the device ID of the respective apparatus 110, 130-k and it may include further information pertaining to the respective apparatus 110, 130-k, such as the respective device-pair-specific encryption key derived for the respective apparatus 110, 130-k.

Referring now to the aspect of transmitting the list of apparatuses admitted to the site control network 105 to the server entity 150 (cf. block 206), transfer of said list to the server entity 150 may be carried out over a secure connection to ensure confidentiality of the transmitted data, where security mechanisms known in the art may be applied for securing the data transmitted from the network coordinator apparatus 120 to the server entity 150.

Transmission of the list of apparatuses admitted to the site control network 105 to the server entity 150 serves to provide a back-up copy of the list to account for possible loss of the site network configuration information (or part thereof) at the network coordinator apparatus 120 e.g. due to malfunction or due to human error, which may result in the network coordinator apparatus 120 partially or completely losing its capability to manage the site control network 105 in a manner that guarantees security of the site control network 105. As described in the foregoing, in previously known approaches such situation would be solved by re-establishing the site control network 105 via repeating the respective pairing procedure with the one or more further apparatuses 130 e.g. according to operations described in the foregoing with references to block 202. However, such an approach requires manual work that is both cumbersome and prone to human errors, thereby running a risk of prolonged unavailability of passenger transport via operation of the passenger conveyor system 101.

Referring now to the aspect of creating the restored site control network 105′ after at least a partial loss of the site network configuration information (cf. block 208), the network coordinator apparatus 120 may resort to the back-up copy of the list of apparatuses admitted to the site control network 105 transmitted earlier for storage at the server entity 150 and stored therein for subsequent access by the network coordinator apparatus 120. Creation of the restored site control network 105′ based on the copy of the list of apparatuses admitted to the site control network 105 basically includes two phases, i.e. reception of a copy of the list of apparatuses admitted to the site control network 105 from the server entity 150 and usage of the device IDs in the list for re-admission of the respective further apparatuses 130-k via a simplified procedure that avoids the additional burden of repetition of the full-scale pairing procedure for the one or more further apparatuses 130 e.g. according to operations described in the foregoing with reference to block 202.

The aspect of creating the restored site control network 105′ (cf. block 208) may comprise the network coordinator apparatus 120 defining a new network link key to be applied for secure communication over the restored site control network 105′. In this regard, the new network link key may be the same as applied earlier for the site control network 105, whereas more typically creation of the restored site control network 105′ may comprise the network coordinator apparatus 120 generating the new network link key independently of the network link key applied for the site control network 105 before the loss of the network configuration information at the network coordinator apparatus 120. Like the network link key applied for the site control network 105, also the new network link key for the restored site control network 105′ may comprise a (pseudo-)random bit sequence of a desired length. Creation of the restored site control network 105′ may further involve the network coordinator apparatus 120 initiating broadcast of one or more messages that indicate availability of the restored site control network 105', where the one or more messages may include information about characteristics of the restored site control network 105'. The network coordinator 120 may initialize the restored site control network 105′ via admitting the conveyor system controller 110 thereto. This may be accomplished e.g. via the pairing procedure carried out with the conveyor system controller 110 along the lines described in the foregoing.

The aspect of the network coordinator apparatus 120 receiving the list of apparatuses admitted to the site control network 105 from the server entity 150 (cf. block 208a) may comprise transferring the list from the server entity 150 to the network coordinator apparatus 120 over a secure connection to ensure confidentiality of the transmitted data, where security mechanisms known in the art may be applied for securing the data transmitted from the server entity 150 to the network coordinator apparatus 120.

The aspect of the network coordinator apparatus 120 automatically admitting to the restored site control network 105′ apparatuses having their device IDs on the list of apparatuses admitted to the site control network 105 and having the knowledge of the predefined shared secret (cf. block 208b) may involve the network coordinator apparatus 120 admitting an apparatus having its device ID on said list via the following steps:
verifying, at the network coordinator apparatus 120, that the respective apparatus has its device ID on the list of apparatuses admitted to the site control network 105 and that it has a knowledge of the predefined shared secret; and
transmitting, in response to successful verification, from the network coordinator apparatus 120 to the respective apparatus, the new network link key that enables communicating over the site control network (105) in data that is encrypted using the predefined shared secret or using an encryption key derived based on the predefined shared secret.

For clarity of the description, in the following the apparatus attempting to joint the restored site control network 105′ is referred to as a candidate apparatus. This approach for admitting the candidate apparatus to the restored site control network 105′ is applicable for admitting both the one or more further apparatuses 130 and the conveyor system controller 110 to the restored site control network 105′. According to an example, the verification procedure described above may comprise the network coordinator apparatus 120 carrying out the challenge-response authentication according to a predefined procedure with the candidate apparatus in order to confirm that the candidate apparatus has the knowledge of the predefined shared secret, while the challenge-response procedure may also serve to confirm to the candidate apparatus that the network coordinator 120 has the knowledge of the predefined shared secret, thereby verifying it as an apparatus that really manages access to the restored site control network 105′. In another example, the verification may involve the candidate apparatus signing its device ID with the predefined shared secret and transmitting the signed device ID to the network coordinator apparatus 120, which may consider verification of the candidate apparatus successful in response to successful verification of the signature. In this regard, signing the device ID and verification of the signature may be carried out using mechanisms known in the art.

After successful verification of the candidate apparatus the network coordinator apparatus 120 may transmit the new network link key to the candidate apparatus as encrypted data, where the encrypted data may further include other information related to the restored site control network 105′ and/or to communication over the restored site control network 105′. According to an example, this data transmitted from the network coordinator apparatus 120 to the candidate apparatus may be encrypted using the predefined shared secret, whereas according to another example the encryption may be carried out using an encryption key derived based on the predefined shared secret. In the latter example, the encryption key may be a device-pair-specific one and it may be derived at the network coordinator apparatus 120 and at the candidate apparatus using a predefined procedure and/or algorithm provided for this purpose.

Hence, the simplified restoration of the site control network 105 according to operations described with references to block 208 enables a secure manner of admitting the one or more further apparatuses 130 that were earlier admitted to the site control network 105 via the pairing process to the restored site control network 105′ without the need to repeat the full-scale pairing processes for each of the one or more further apparatuses 130, thereby avoiding manual work that is both time-consuming and prone to errors.

The security of the admission procedure according to operations that pertain to block 208b may be further enhanced e.g. via taking one or more of the following measures:
The network coordinator apparatus 120 may be arranged to allow using each device ID included in the list of apparatuses admitted to the site control network 105 to be used for re-admission only once.
The network coordinator apparatus 120 may be arranged to allow admission to the restored site control network 105′ only during a time period of predefined duration that (immediately) follows creation of the restored site control network 105′. In non-limiting examples, the time period may have a duration within a range from a few minutes to a few hours.
The network coordinator apparatus 120 may be arranged to allow re-admission to the site control network only during the time period of predefined duration that is initiated by user input received via the user interface provided for the network coordinator apparatus 120.

Each of the exemplifying approaches above serve to reduce the risk of a malicious party that has gained access both to the device ID of a certain further apparatus 130-k and the predefined shared secret and trying to use these pieces of information to have access to the restored site control network 105′.

Each of the one or more further apparatuses 130 may be arranged to react to loss of the site control network 105 in a manner that enables timely re-admission to the restored site control network 105′. Non-limiting examples in this regard include the following:
The further apparatus 130-k may be arranged to respond to inability to communicate over the site control network 105 by automatically transmitting requests to join a network of a similar type with the site control network 105, where these requests may be transmitted according to a predefined schedule (e.g. at predefined time intervals).
The further apparatus 130-k may be arranged to respond to inability to communicate over the site control network 105 by transmitting requests to join a network of a similar type with the site control network 105 in response to receiving messages that indicate availability of such a network.

In both examples described above, the automated transmission of the requests may be initiated by the loss of the site control network 105 for a time period having a duration that exceeds a predefined threshold duration.

In the examples described above with references to FIGS. 1 and 2 both the initial creation of the site control network 105 and its restoration via creation of the restored site control network 105′ after the loss of site network configuration data takes place at the (same) network coordinator apparatus 120. However, in some scenarios the malfunction that results in loss of the site network configuration information at the network coordinator apparatus 120 may result in replacement of the network coordinator apparatus 120 with a new one, whereas a situation that requires creation of the restored site control network 105′ may occur also when the network coordinator apparatus 120 is replaced with a new one due to hardware and/or software upgrade.

In this regard, FIG. 3 illustrates a block diagram of some logical elements of the people flow system 100 according to another example, which includes the elements of the example of FIG. 1 apart from the network coordinator 120, which is replaced by a replacement network coordinator 120′. In particular, the site control network 105 may be originally created using the network coordinator 120 (shown in FIG. 1), which may be replaced by the replacement network coordinator 120′ (shown in FIG. 3) after the loss of the site network configuration information at the network controller 120. Along the lines described in the foregoing for the ‘original’ network coordinator 120, according to an example, the replacement network coordinator 120′ may be implemented in an apparatus that is separate from the other nodes of the restored site control network 105', e.g. as a replacement network coordinator apparatus (as in the example of FIG. 3), whereas in another example the replacement network coordinator 120′ may be implemented as an entity of another node of the restored site control network 105', e.g. as part of the conveyor system controller 110.

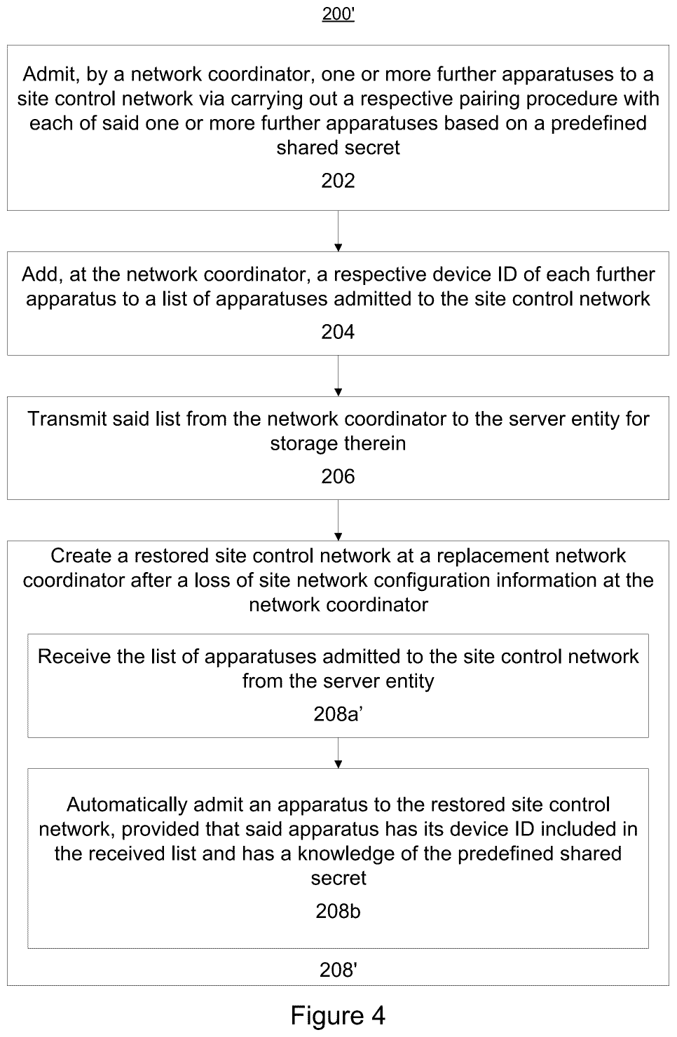

Moreover, FIG. 4 illustrates a method 200′, which is a variation of the method 200, where respective operations that pertain to blocks 202 to 206 of the method 200′ are similar to those of the method 200 and they may be implemented as described the foregoing. In contrast respective operations that pertain to block 208′ are implemented by the replacement network coordinator 120′ (e.g. by the replacement coordinator apparatus) instead of implementing corresponding operations of block 208 (of the method 200) in the network coordinator apparatus 120.

Hence, in the method 200′ the operations that pertain to block 208′ may be preceded by introducing the replacement network coordinator apparatus 120′ to the control system 102 of the people flow system 100, whereas the operations that pertain to block 208′ may include the following step(s) carried out at the replacement network coordinator apparatus 120′:
create the restored site control network 105′ at the replacement network coordinator 120′ after a loss of the site network configuration information at the network coordinator (120), said creating comprising:
   receiving the list of apparatuses admitted to the site control network 105 from the server entity 150 (208a), and
   automatically admitting an apparatus to the restored site control network 105′, provided that said apparatus has its device ID included in the received list and knowledge of the respective shared secret established between the site network coordinator 120 and the respective one of said one or more further apparatuses 130-k (208b).

The examples of implementing the operations of block 208 of the method 200 provided in the foregoing apply to the operations of block 208′ of the method 200′, mutatis mutandis, with the exception of these operations being carried out by the replacement network coordinator 120′ instead of the (original) network coordinator 120.

In the examples described in the foregoing, the copy of list of apparatuses admitted to the site control network 105 is transmitted for storage in the server entity 150 and transmitted from the server entity to one of the (original) network coordinator 120 and the replacement network coordinator 120′, whichever will be applied in creating the restored site control network 105′. In respective variations of the above-described examples the list of apparatuses admitted to the site control network 105 may be transmitted for storage in and received for creation of the restored site control network 105′ from another entity, which may comprise e.g. the conveyor controller 110. However, this variation is not applicable in scenarios where the network coordinator is provided as an entity of the conveyor system controller 120.

Along the lines described in the foregoing, each of the conveyor controller 110, the network coordinator 120, the replacement network coordinator 120′ and the one or more further apparatuses 130 may comprise or may be provided using one or more computer apparatuses, each comprising respective one or more processors arranged to execute one or more computer programs to provide at least some aspects of operation of the respective one of the conveyor controller 110, the network coordinator 120, the replacement network coordinator 120′ and the one or more further apparatuses 130. As an example in this regard, a computer apparatus 300 illustrated by the block diagram of FIG. 5 may be applied.

The apparatus 300 comprises a processor 310 and a memory 320. The memory 320 may store data and computer program code 325. The apparatus 300 may further comprise communication means 330 for wired or wireless communication with other apparatuses and/or user I/O (input/output) components 340 that may be arranged, together with the processor 310 and a portion of the computer program code 325, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 300 are communicatively coupled to each other via a bus 350 that enables transfer of data and control information between the components.

The memory 320 and a portion of the computer program code 325 stored therein may be further arranged, with the processor 310, to cause the apparatus 300 to perform at least some aspects of operation of the respective one of the conveyor controller 110, the network coordinator 120, the replacement network coordinator 120′ and the one or more further apparatuses 130. The processor 310 is configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement at least some aspects of operation of the respective one of the conveyor controller 110, the network coordinator 120, the replacement network coordinator 120′ and the one or more further apparatuses 130 when loaded into the processor 410. As an example, the computer program code 425 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus 300 to perform at least some aspects of operation of the respective one of the conveyor controller 110, the network coordinator 120, the replacement network coordinator 120′ and the one or more further apparatuses 130. Hence, the apparatus 300 may comprise at least one processor 310 and at least one memory 320 including the computer program code 325 for one or more programs, the at least one memory 320 and the computer program code 325 configured to, with the at least one processor 310, cause the apparatus 300 to perform at least some aspects of operation of the respective one of the conveyor controller 110, the network coordinator 120, the replacement network coordinator 120′ and the one or more further apparatuses 130.

The computer program code 325 may be provided e.g. a computer program product comprising at least one computer-readable non-transitory medium having the computer program code 325 stored thereon, which computer program code 325, when executed by the processor 310 causes the apparatus 300 to perform at least some aspects of operation of the respective one of the conveyor controller 110, the network coordinator 120, the replacement network coordinator 120′ and the one or more further apparatuses 130. The computer-readable non-transitory medium may comprise a memory device, a record medium or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

1. A method for managing access to a site control network of a people flow system that includes a passenger conveyor system and a conveyor system controller, where the site control network communicatively couples the conveyor system controller to a network coordinator and to one or more further apparatuses, the method comprising:
admitting, by the network coordinator, the one or more further apparatuses to the site control network via carrying out a respective pairing procedure with each of said one or more further apparatuses based on a predefined shared secret;
adding, by the network coordinator, a respective device identifier, ID, of each further apparatus to a list of apparatuses admitted to the site control network;
transmitting said list from the network coordinator to an external entity for storage therein; and
creating, following a loss of site network control information in the network coordinator, a restored site control network in one of the network coordinator or the replacement network coordinator, said creating comprising
receiving said list from the external entity; and
automatically admitting an apparatus to the restored site control network, provided that said apparatus has its device ID included in said list and has a knowledge of the predefined shared secret.

2. A method according to claim 1, wherein said restoring is carried out in the network controller.

3. A method according to claim 1, wherein said restoring is carried out in the replacement network controller.

4. A method according to claim 1, wherein the external entity comprises an external server entity that is communicatively coupled to the network coordinator independently of the site control network

5. A method according to claim 1, wherein the external entity comprises the conveyor system controller.

6. A method according to claim 1, wherein each device ID included in said list is available for admission to the restored site control network only once.

7. A method according to claim 1, wherein re-admission to the restored site control network is allowed only during a time period of a predefined duration that follows creation of the restored site control network.

8. A method according to claim 1, wherein re-admission to the restored site control network is allowed only during a time period of a predefined duration initiated in response to user input received via a user interface provided for the respective one of the network coordinator or the replacement network coordinator.

9. A method according to claim 1, wherein said admitting comprises:
receiving, at the network coordinator and at the respective further apparatus respective user inputs that initiate the pairing procedure;
authenticating the respective further apparatus at the network coordinator
verifying, at the network coordinator, that the respective further apparatus has a knowledge of the predefined shared secret; and
transmitting, in response to successful verification, from the network coordinator to the respective further apparatus, a network link key that enables communicating over the site control network in data that is encrypted using the predefined shared secret or using an encryption key derived based on the predefined shared secret.

10. A method according to claim 1, wherein said automatically admitting comprises:
verifying, at the network coordinator, that said apparatus has its device ID included in said list and has the knowledge of the predefined shared secret; and
transmitting, in response to successful verification, from the network coordinator to said apparatus, a new network link key that enables communicating over the restored site control network in data that is encrypted using the predefined shared secret or using an encryption key derived based on the predefined shared secret.

11. A method according to claim 1, wherein the predefined shared secret is pre-stored at the network coordinator and at the one or more further apparatuses.

12. An apparatus for managing access to a site control network of a people flow system that includes a passenger conveyor system and a conveyor system controller, where the site control network communicatively couples the conveyor system controller to the apparatus and to one or more further apparatuses, the apparatus arranged to:
admit the one or more further apparatuses to the site control network via carrying out a respective pairing procedure with each of said one or more further apparatuses based on a predefined shared secret;
add a respective device identifier, ID, of each further apparatus to a list of apparatuses admitted to the site control network;
transmit said list to an external entity for storage therein; and
create, following a loss of site network control information in the apparatus, a restored site control network, said creating comprising the apparatus arranged to:
receive said list from the external entity, and
automatically admit another apparatus to the restored site control network, provided that said another apparatus has its device ID included in said list and has a knowledge of the predefined shared secret.

13. A control system for managing access to a site control network of a people flow system that includes a passenger conveyor system and a conveyor system controller, where the site control network communicatively couples the conveyor system controller to a network coordinator apparatus and to one or more further apparatuses, the control system comprising:
the network coordinator apparatus arranged to:
admit the one or more further apparatuses to the site control network via carrying out a respective pairing procedure with each of said one or more further apparatuses based on a predefined shared secret,
add a respective device identifier, ID, of each further apparatus to a list of apparatuses admitted to the site control network, and
transmit said list to an external entity for storage therein; and
a replacement network coordinator apparatus arranged to create, following a loss of site network control information in the network coordinator apparatus, a restored site control network, said creating comprising the replacement network coordinator apparatus arranged to:
receive said list from the external entity; and
automatically admit another apparatus to the restored site control network, provided that said another apparatus has its device ID included in said list and has a knowledge of the predefined shared secret.

14. A non-transitory computer readable medium storing a computer program comprising computer readable program code configured to cause performing at least the method according to claim 1 when said program code is executed on one or more computing apparatuses.

15. A method according to claim 2, wherein the external entity comprises an external server entity that is communicatively coupled to the network coordinator independently of the site control network.

16. A method according to claim 3, wherein the external entity comprises an external server entity that is communicatively coupled to the network coordinator independently of the site control network.

17. A method according to claim 2, wherein the external entity comprises the conveyor system controller.

18. A method according to claim 3, wherein the external entity comprises the conveyor system controller.

19. A method according to claim 2, wherein each device ID included in said list is available for admission to the restored site control network only once.

20. A method according to claim 3, wherein each device ID included in said list is available for admission to the restored site control network only once.
